(19) United States
(12) Patent Application Publication
(10) Pub. No.: US 2018/0096438 A1
(43) Pub. Date: Apr. 5, 2018

(54) System and Method of Event Planning through a Social Network

(71) Applicant: James Gaffney, Provo, UT (US)

(72) Inventor: James Gaffney, Provo, UT (US)

(21) Appl. No.: 15/726,361

(22) Filed: Oct. 5, 2017

Related U.S. Application Data
(60) Provisional application No. 62/404,524, filed on Oct. 5, 2016.

(51) Int. Cl. G06Q 50/00; G06Q 10/10

(52) U.S. Cl. CPC G06Q 50/01; G06Q 10/1095

(57) ABSTRACT

A method of event planning through a social network requires at least one remote server and a corresponding personal computing device. The at least one remote server stores the information of each planned-event location, event posting, and user account. The method begins by receiving a planned-event location from the corresponding PC device. An event posting is generated based on the planned-event location with the remote server. A plurality of related user accounts is designated to the arbitrary account based on the user relationships with the remote server. An event notification for the event posting is sent to the corresponding PC device of each related account. Each related account is prompted to send an event confirmation for the event posting through the corresponding PC device. If the remote server receives the event confirmation, at least one attendee account is designated for the event posting with the remote server.

The current application claims priority to U.S. provisional application Ser. No. 62/404,524 filed on Oct. 5, 2016.

### FIELD OF THE INVENTION

The present invention generally relates to event planning. More specifically, the present invention allows a user to plan an event through a social network.

### BACKGROUND OF THE INVENTION

Traditionally, people have had to rely on phone books, local advertisements through newsprint and television, or physically going out and searching around the area to find restaurants to eat at or activities to do nearby. With the surge of mobile electronic devices like smartphones and tablet computers that utilize Global Positioning Systems (GPS) or other location-based technologies, finding nearby businesses has become vastly easier. Furthermore, the ease of communication afforded by such devices along with their increased processing speeds and higher data transmission rates have allowed individuals to increase their ability to plan and coordinate events, share useful information, and socially interact with others that share similar interests.

The present invention allows people to easily communicate and contact each other while encouraging the gathering of friends over a social media platform. The present invention facilitates the planning of events and the process of organizing people. More specifically, the present invention allows people to designate a convenient and appropriate location for a gathering.

### BRIEF DESCRIPTION OF THE DRAWINGS

FIG. 1 is a schematic view of the wireless communication between at least one server and a plurality of corresponding portable computing devices of the present invention.

FIG. 2 is a flowchart illustrating the overall process for the present invention.

FIG. 3 is a flowchart illustrating the overall process for receiving the physical address as the planned-event location from a textual entry by the arbitrary account.

FIG. 4 is a flowchart illustrating the overall process receiving the physical address as the planned-event location from the display of the interactive geospatial map.

FIG. 5 is a flowchart illustrating the overall process receiving the physical address as the planned-event location from the display of the interactive geospatial map and the application of the location filter.

FIG. 6 is a flowchart illustrating the overall process receiving the physical address as the planned-event location from the display of the interactive geospatial map and summarization information of the potential location.

FIG. 7 is a flowchart illustrating the overall process for graphically listing the plurality of future-endeavor locations.

FIG. 8 is a flowchart illustrating the overall process for displaying the in-depth description of the potential location.

FIG. 9 is a flowchart illustrating the overall process for chronologically integrating the desired date-and-time of the event posting into the interactive calendar.

FIG. 10 is a flowchart illustrating the overall process for storing an association between the arbitrary account and the matching location.

FIG. 11 is a flowchart illustrating the overall process for filtering the plurality of related accounts based on the filter on the marital status with the remote server.

FIG. 12 is a flowchart illustrating the overall process for appending the likeability score into the summarization information of the new notable event location with the remote server.

FIG. 13 is a flowchart illustrating the overall process for appending the textual review into the summarization information of the new notable event location with the remote server.

FIG. 14 is a flowchart illustrating the overall process for appending the new notable event location into the plurality of notable event locations with the remote server.

FIG. 15 is a flowchart illustrating the overall process appending the edit/response into the summarization information for the new notable event location with the remote server.

### DETAIL DESCRIPTIONS OF THE INVENTION

All illustrations of the drawings are for the purpose of describing selected versions of the present invention and are not intended to limit the scope of the present invention.

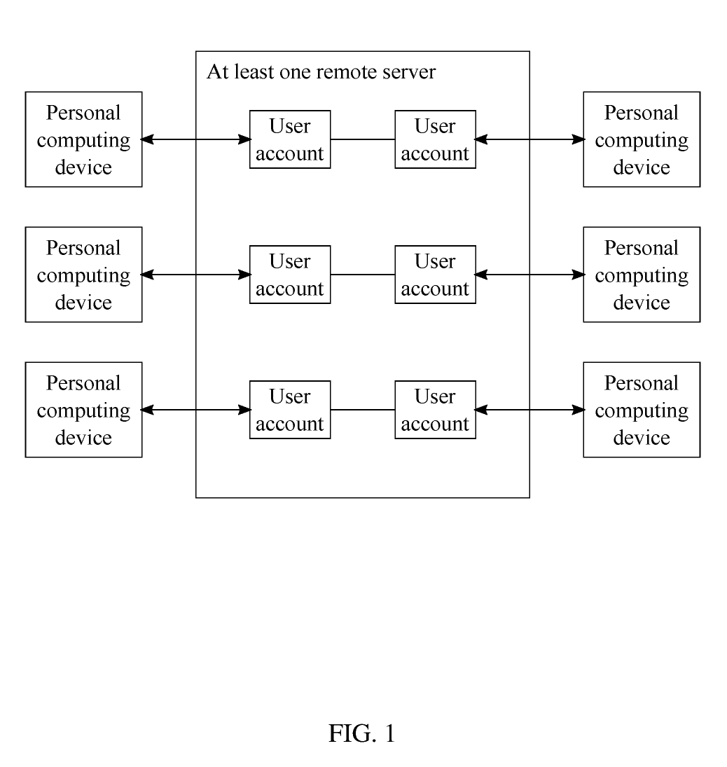

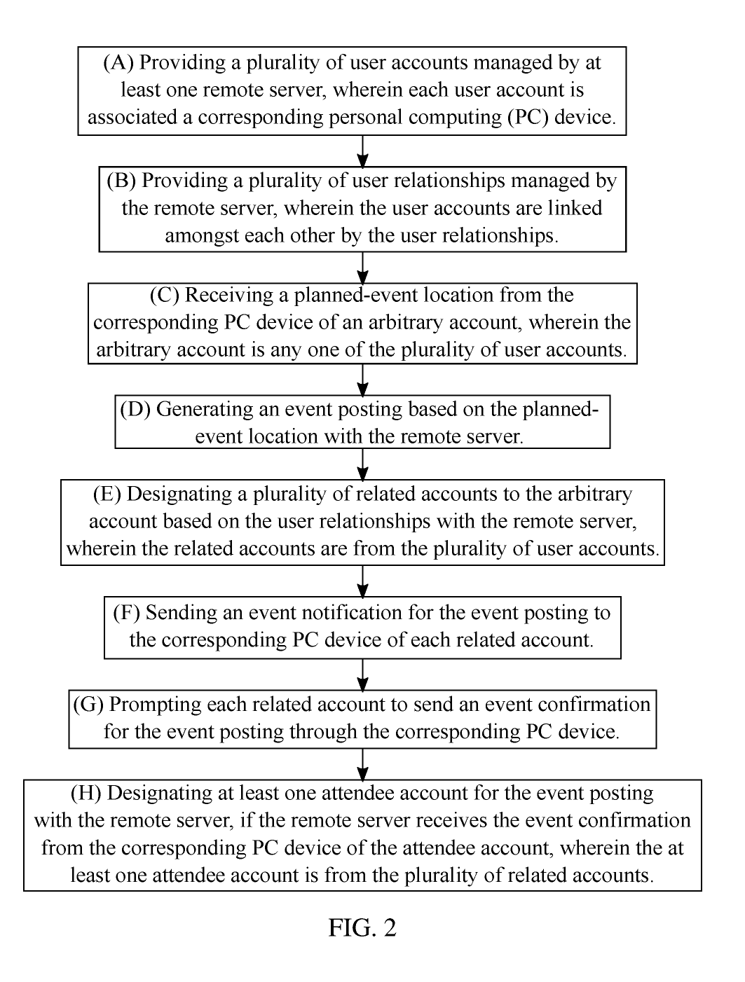

The present invention is a system and method of event planning through a social network. The present invention facilitates the communication between users in order to create an event. Such events include dinners, parties, happy hour, and so on. The present invention maximizes the options of a location for an event. Thus, the physical system used to implement the method of the present invention includes at least one remote server and a corresponding personal computing (PC) device (Step A), as seen in FIG. 1. The at least one remote server stores data regarding each corresponding PC device, event locations, and associated information regarding each event location. The corresponding PC device allows a user to perform computer functions regarding the planning of an event. The corresponding PC device allows a user to communicate with other corresponding PC devices through the remote server. The corresponding PC device, may include but is not limited to, a smart-phone, a laptop, and a tablet. Moreover, a plurality of user accounts is managed by at least one remote server, wherein each user account is associated with a corresponding PC device (Step A), as shown in FIG. 2. Each user account allows a user to create an event, search for locations, organize events, and organize locations he or she wishes to visit in the future. A plurality of user relationships is managed by the remote server, where the plurality of user accounts is linked amongst each other by the user relationships (Step B). The plurality of user relationships allows a user account to designate to directly communicate with linked user accounts through corresponding PC devices. A user relationship of the plurality of user relationships may

The overall process for the present invention, shown in FIG. 2, includes the following steps that are implemented with the at least one remote server and the corresponding PC device. The overall process begins with receiving a planned-event location from the corresponding PC device of an arbitrary account, where the arbitrary account can be any one of the plurality of user accounts (Step C). The planned-event location is the designated venue, restaurant, or home by the arbitrary account. An event posting is then generated based on the planned-event location with the remote server (Step D). The event-posting presents the necessary information regarding the event so that other users may attend. A plurality of related accounts is designated to the arbitrary account based on the user relationships with the remote server, where the related accounts are from the plurality of user accounts so that the arbitrary account may easily invite specific user accounts (Step E). The plurality of related accounts allows the arbitrary account to easily identify and communicate with specific user accounts. The plurality of related accounts is similar to contacts, friends of social media accounts, followers of social media accounts, and so on. The present invention sends an event notification for the event posting to the corresponding PC device of each related account so that each related account may view event notification (Step F). The event notification serves as an alert for each of the plurality of related accounts and requests a response. The event notification is viewable on each of the corresponding PC devices. Each related account is prompted to send an event confirmation for the event positing through the corresponding PC device (Step G) so that each related account can respond to the event notification. At least one attendee account is designated for the event posting with the remote server so that the arbitrary account may be alerted of the action of each related account. The arbitrary account may implement further actions for the event based on the designation of the at least one attendee account. The designation of the at least one attendee occurs only if the remote server receives the event confirmation from the corresponding PC device of the attendee account, where the at least one attendee account is from the plurality of related accounts (Step H).

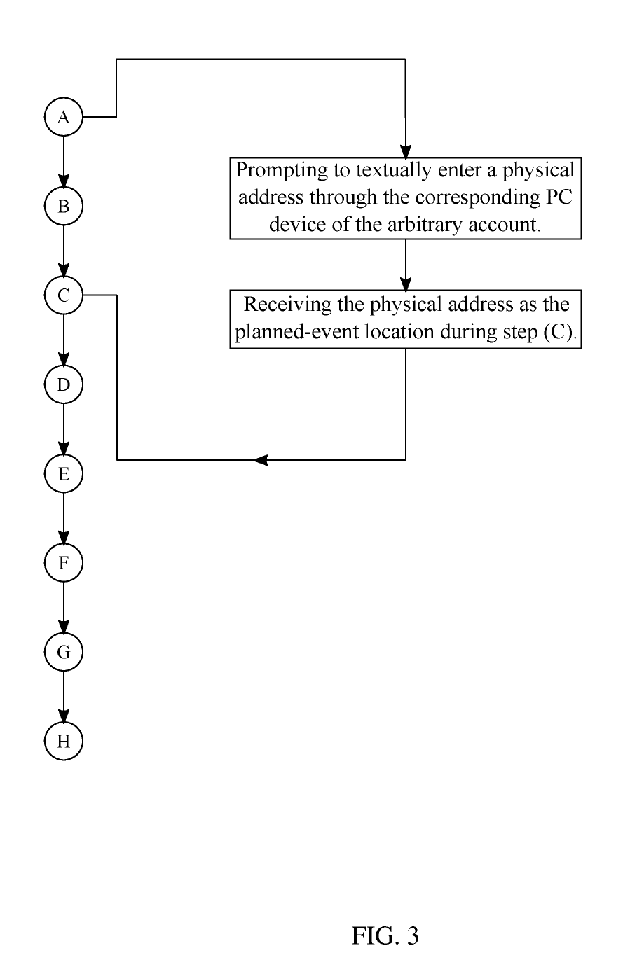

In order to plan the event details, the arbitrary account is prompted to textually enter a physical address through the corresponding PC device of the arbitrary account, as shown in FIG. 3. The physical address includes the street address, the city, the state, and the zip code of a specific location. The physical address is received as the planned-event location during Step C. Alternatively, in order to facilitate the designation of the planned-event location, an interactive geospatial map is displayed with the corresponding PC device of the arbitrary account. The interactive geospatial map serves as a visual aid that presents planned-event location relative to other available locations and the corresponding PC device of the arbitrary account. The arbitrary account is prompted to graphically select a physical address on the interactive geospatial map through the corresponding PC device of the arbitrary account. The physical address is received as the planned-event location during Step C so that the plurality of related accounts that are made aware of the physical address.

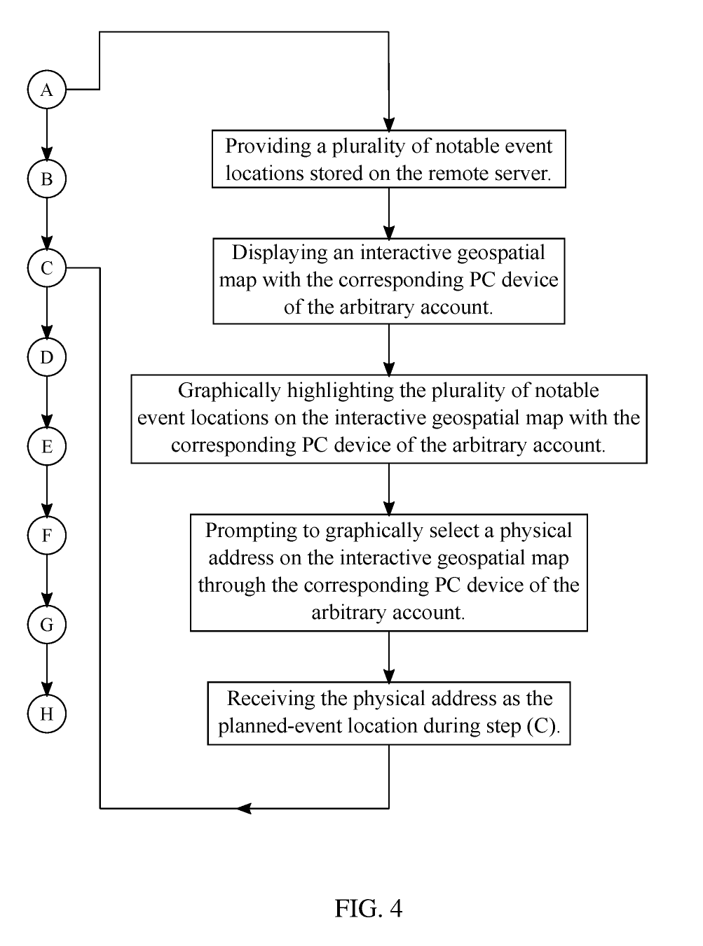

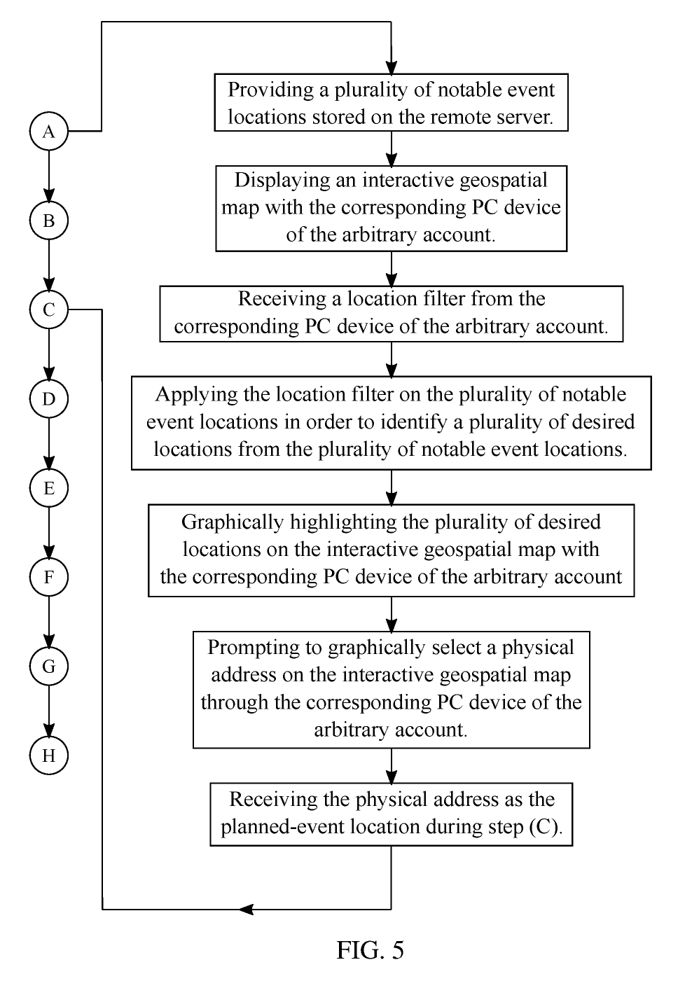

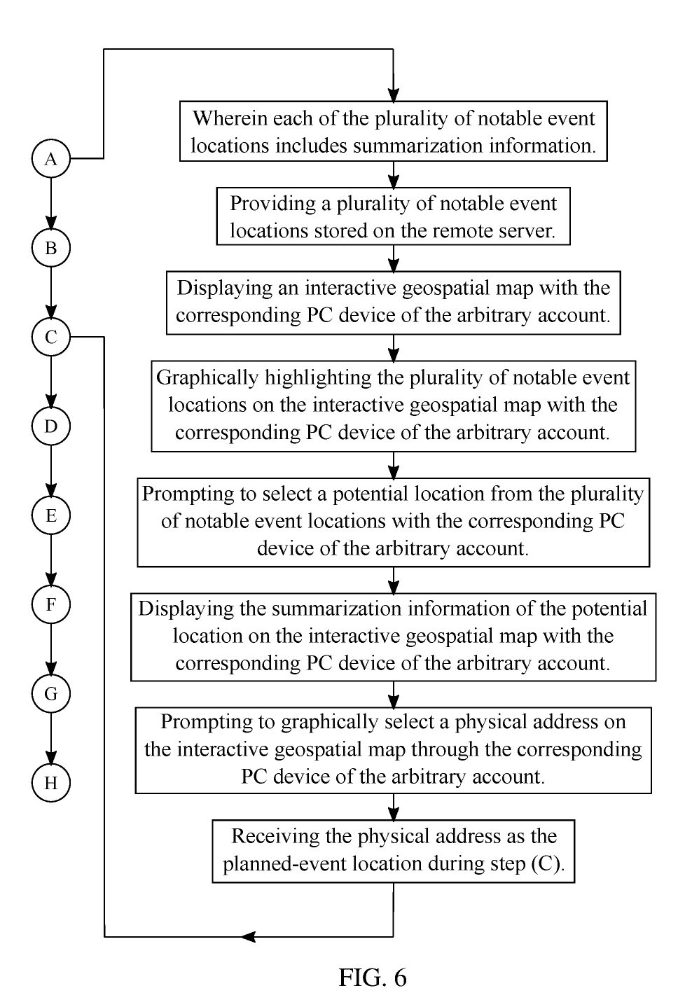

In order to select a desired and the most appropriate planned-event location, a plurality of notable event locations is stored on the remote server. The plurality of notable event locations may include restaurants, bars, lounges, and a variety of other locations or venues accommodate the specific criteria of the arbitrary account for the event. As seen in FIG. 4, the arbitrary account is presented with and chooses a planned-event location among the plurality of notable event locations as the plurality of notable event locations are graphically highlighted on the interactive geospatial map with the corresponding PC device of the arbitrary account. This serves as a visual aid to the arbitrary account, facilitating the designation of the planned-event location based on location. In order for the arbitrary account to sort through the plurality of notable event locations, a location filter is received from the corresponding PC device of the arbitrary account, as seen in FIG. 5. The location filter may include, but is not limited to, a city, a zip code, and a county. The location filter is applied on the plurality of notable event locations in order to identify a plurality of desired locations from the plurality of notable event locations. The plurality of desired locations is graphically highlighted on the interactive geospatial map with the corresponding PC device of the arbitrary account, thereby preventing the geospatial map from being cluttered and reducing the amount of time that the arbitrary account needs to sort through of each of the notable event location of the plurality of notable event locations. The most appropriate planned-event location according to specific criteria of the arbitrary account is efficiently and accurately selected as each of the plurality of notable event locations includes summarization information. Summarization information includes, but is not limited to, business hours, services, menus, and so on. The arbitrary account is prompted to select a potential location from the plurality of notable event locations with the corresponding PC device of the arbitrary account. The potential location from the plurality of notable event locations is a notable event location that may fulfill most, if not all, of the criteria of the arbitrary account for the event. Then, as seen in FIG. 6, the summarization information of the potential location is displayed on the interactive geospatial map with the corresponding PC device of the arbitrary account. The arbitrary account makes an informed decision regarding the planned-event location.

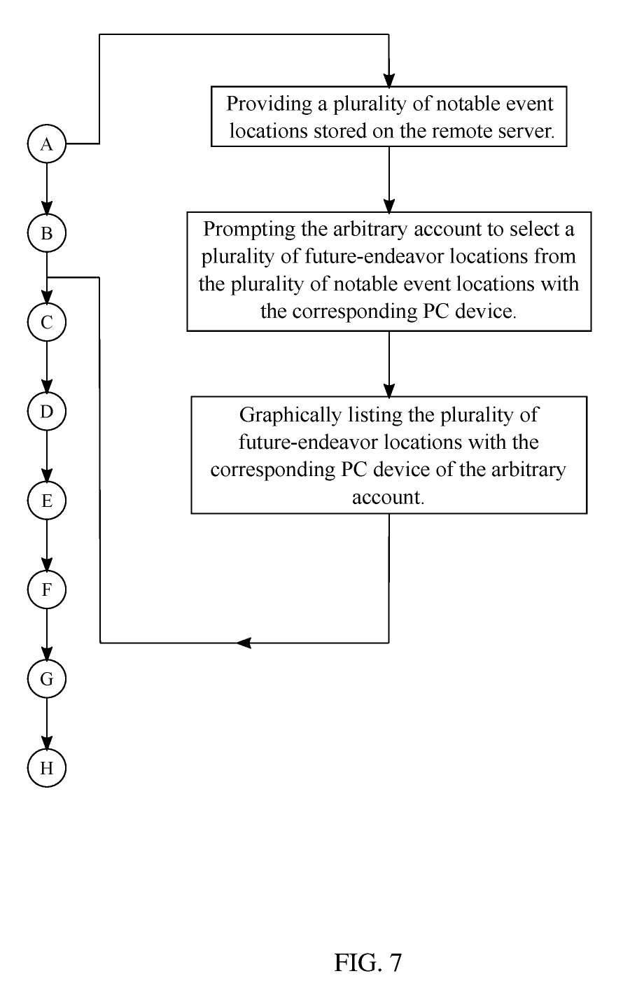

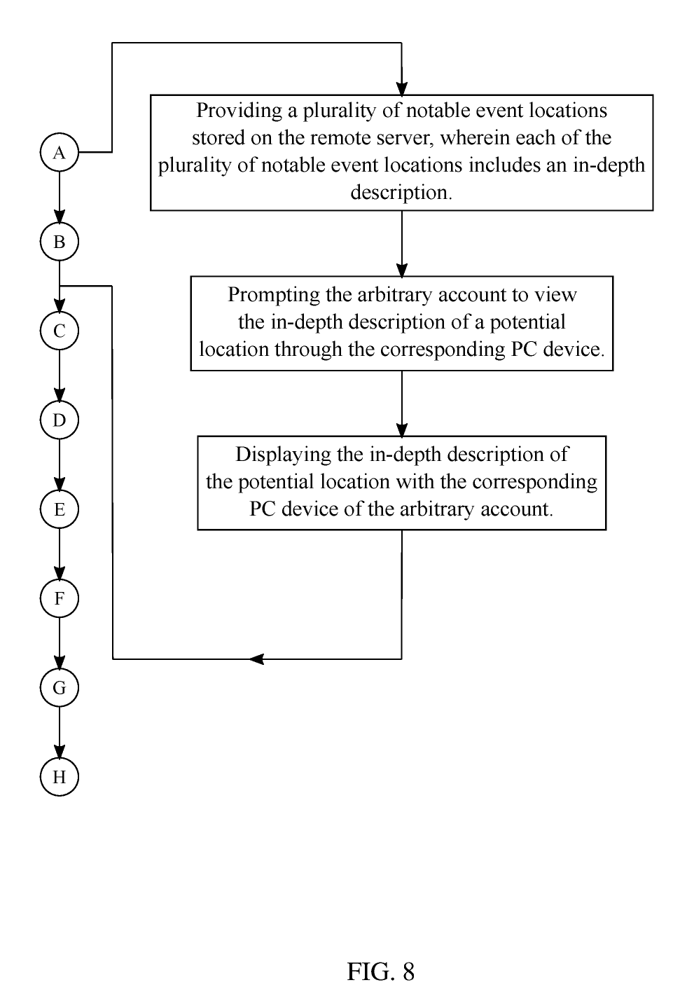

While presented with and view the plurality of notable event locations, the arbitrary account may be presented with a notable event location of the plurality of notable event locations that is best suited for another or a future event. The arbitrary account makes record of the notable event location of the plurality of notable event locations as the arbitrary account is prompted to select a plurality of future-endeavor locations from the plurality of notable event locations with the corresponding PC device, seen in FIG. 7. The plurality of future-endeavor locations is graphically listed with the corresponding PC device of the arbitrary account serving as a visual aid for the selection of the arbitrary account. The arbitrary account may limit the total amount of the plurality of future-endeavor locations as each of the plurality of notable event locations includes an in-depth description, thereby presenting the arbitrary account with more information. As shown in FIG. 8, the arbitrary account is prompted to view the in-depth description of a potential location through the corresponding PC device, and the in-depth description of the potential location is displayed with the corresponding PC device of the arbitrary account. The in-depth description provides the arbitrary account with specific information regarding the potential location allowing the arbitrary account to select potential locations based on specific criteria.

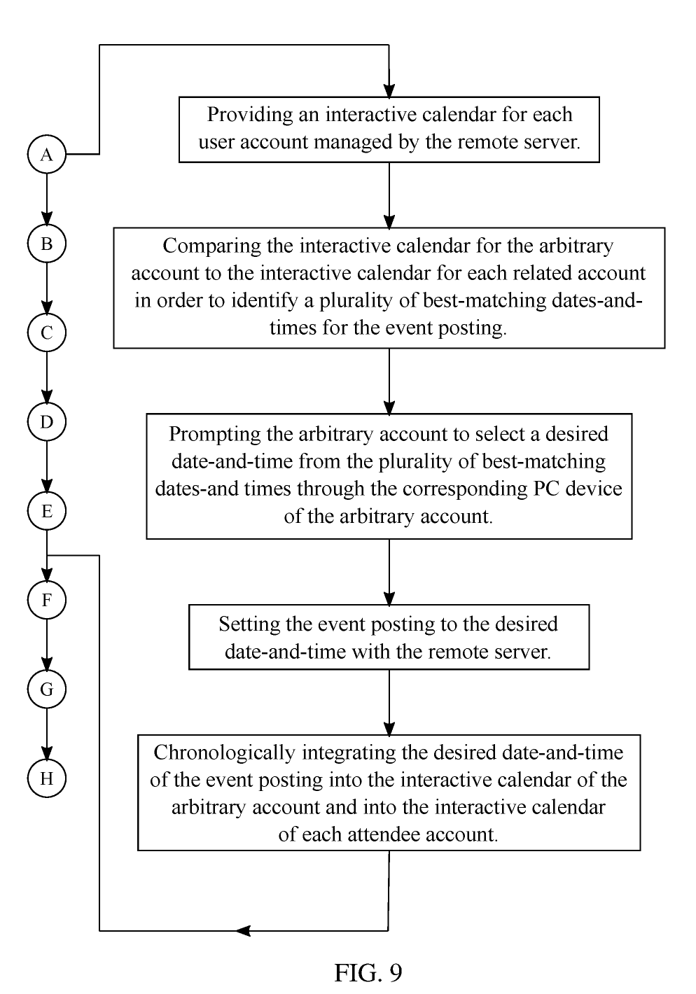

In order to efficiently designate a date and time for the event posting, an interactive calendar for each user account is managed by the remote server, as seen in FIG. 9. The interactive calendar for the arbitrary account is compared to the interactive calendar for each related account in order to identify a plurality of best-matching dates-and-times for the event posting. The arbitrary account is prompted to select a desired date-and-time from the plurality of best-matching dates-and-times through the corresponding PC device of the arbitrary account, thereby reducing the confusion and communication between the arbitrary account and the plurality of related accounts that have received an event notification from the arbitrary account. Further simplifying the decision process, the desired date-and-time of the event posting is chronologically integrated into the interactive calendar of the arbitrary account and into the interactive calendar of each attendee account. The event posting is then set to the desired date-and-time with the remote server, providing each related account with the correct event posting information.

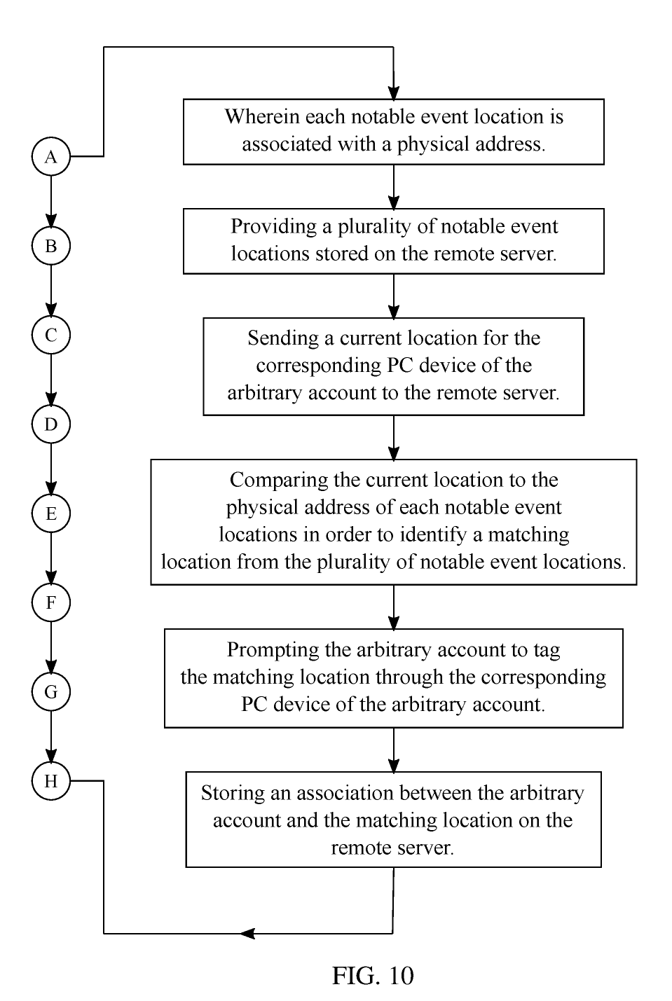

The arbitrary account is able to check-in to the notable event location of the plurality of notable event locations as each notable event location is associated with a physical address. The arbitrary account may check-in to the notable event location so that the plurality of related accounts may be notified or alerted of the action of the arbitrary account. The plurality of related accounts may select the corresponding notable event location as a planned-event location. An account associated with the notable event location may also be alerted of the check-in of the arbitrary account, then accessing and analyzing the frequency of the check-ins of the arbitrary account. As shown in FIG. 10, a current location for the corresponding PC device of the arbitrary account is sent to the remote server, utilizing the Global Positioning System of the PC device. The current location is then compared to the physical address of each notable event locations in order to identify a matching location from the plurality of notable event locations. The arbitrary account is prompted to tag the matching location through the corresponding PC device of the arbitrary account. An association is then stored between the arbitrary account and the matching location on the remote server.

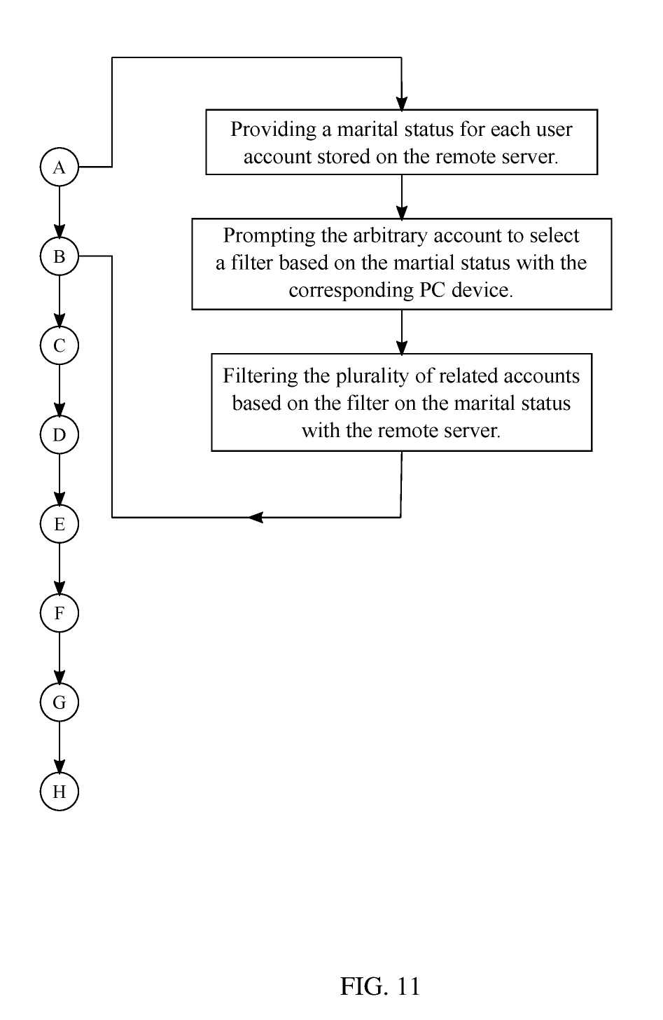

The arbitrary account may connect with the plurality of related accounts based on the marital status for each user account stored on the remote server. As seen in FIG. 11, in order to create an event post based on marital status, the arbitrary account is prompted to select a filter based on the marital status with the corresponding PC device. The plurality of related accounts is filtered based on the filter based on the marital status with the remote server. This allows a single or married arbitrary account to connect with single or married related accounts, respectively.

Once the arbitrary account and each attendee account have arrived at the planned-event location, the arbitrary account and each attendee account may record the notable event location of the plurality notable event locations so that the notable event location is quickly identifiable. As shown in FIG. 10, the arbitrary account and each attendee account are prompted to tag the planned-event location with the corresponding PC device. An association is stored between the arbitrary account and the planned-event location on the remote server. Similarly, an association is stored between each attendee account and the planned-event location on the remote server. The association between the arbitrary account and the planned-event location and the association between each attendee account and the planned-event location are compiled into a new notable event location with the remote server. The new notable event location is appended into the plurality of notable event locations with the remote server, thereby allowing the arbitrary account to confirm attendance for the event.

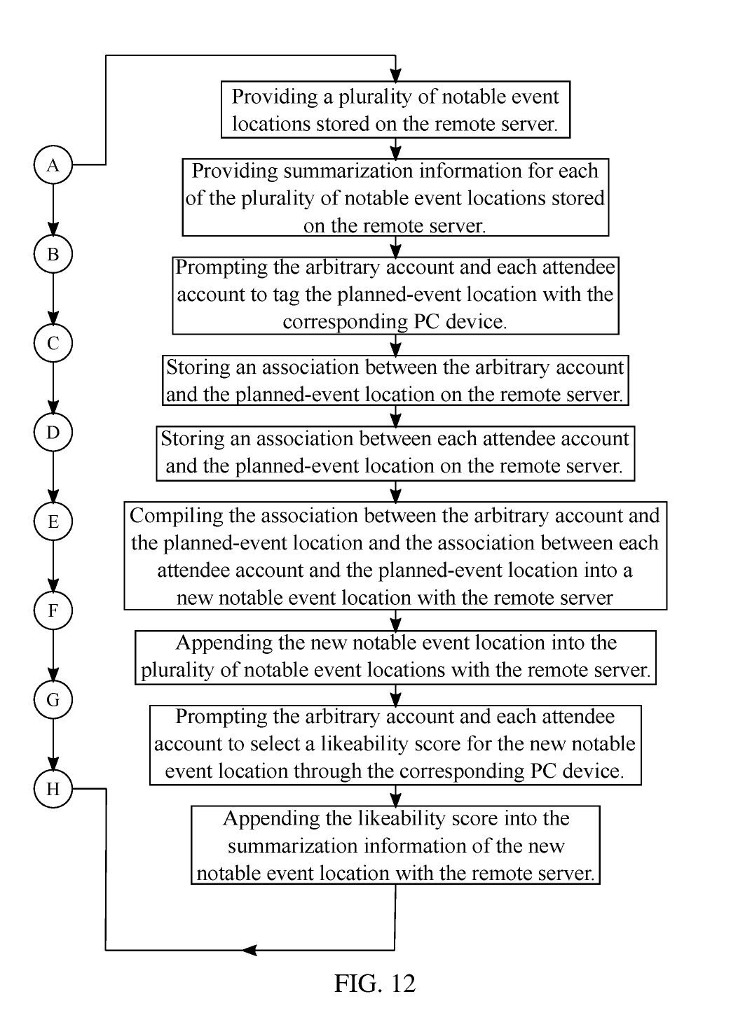

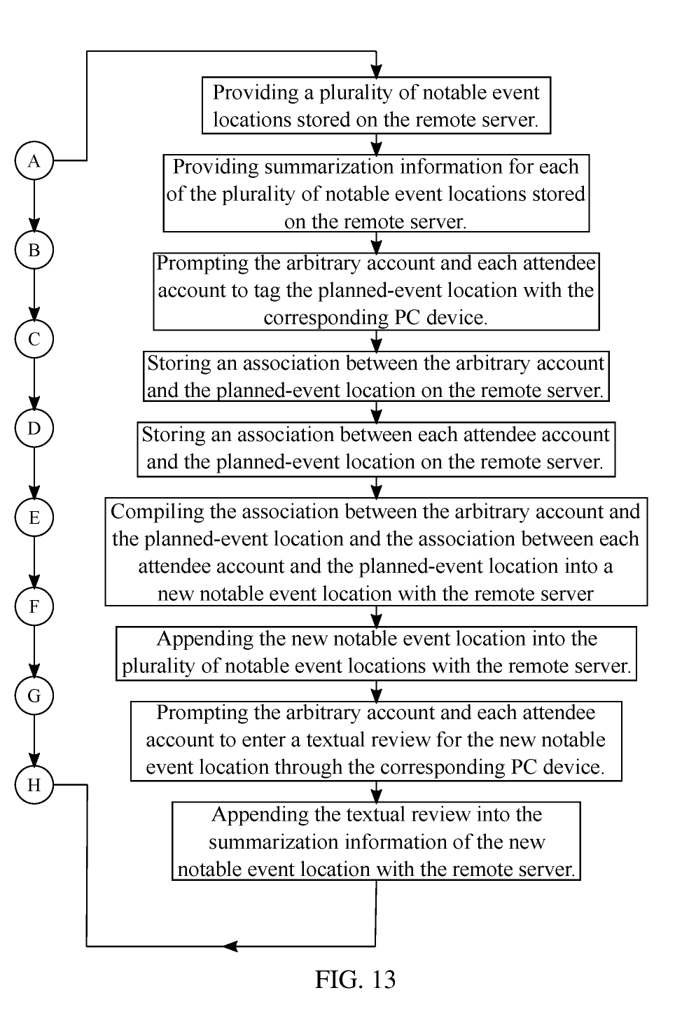

The arbitrary account and each attendee account may provide summarization information for each of the plurality of notable event locations stored on the remote server, such as feedback. The arbitrary account and each attendee account may rate each of the plurality of notable event locations or input a review for each of the plurality of notable event locations. In order to rate the notable event location, the arbitrary account and each attendee account are prompted to select a likeability score for the new notable event location through the corresponding PC device, as seen in FIG. 12. The likeability score is appended into the summarization information of the new notable event location with the remote server in order for other user accounts to effectively access the notable event location. In order to input a review for the notable event location, arbitrary account and each attendee account are prompted to enter a textual review for the new notable event location through the corresponding PC device, seen in FIG. 13. The textual review is appended into the summarization information of the new notable event location with the remote server for the other user accounts to effectively access the notable event location.

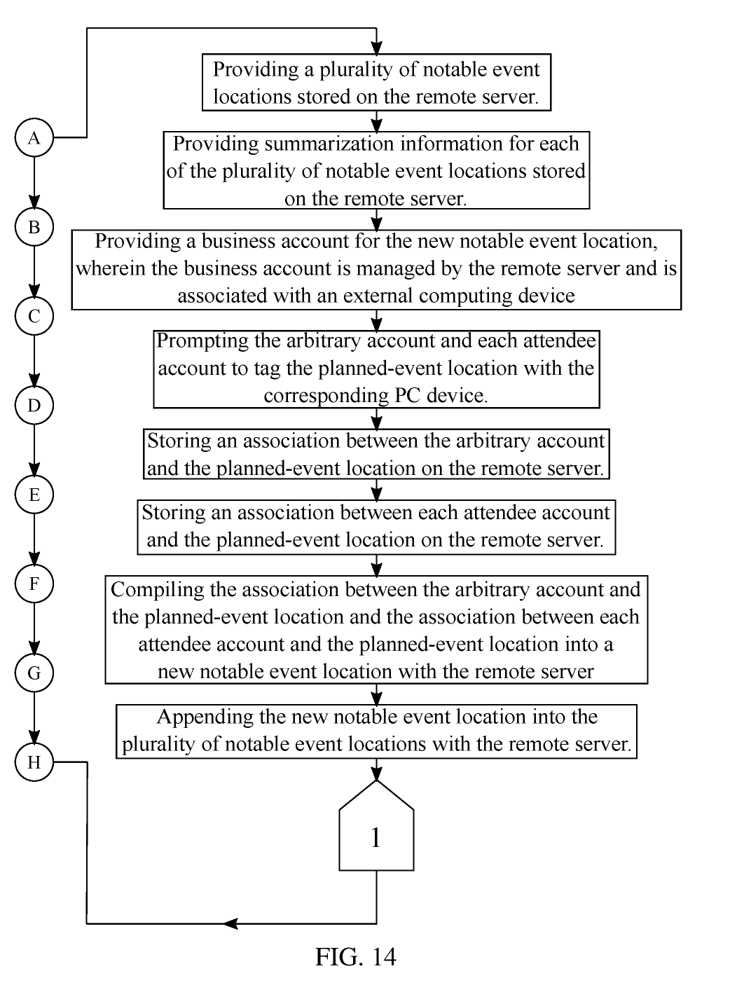

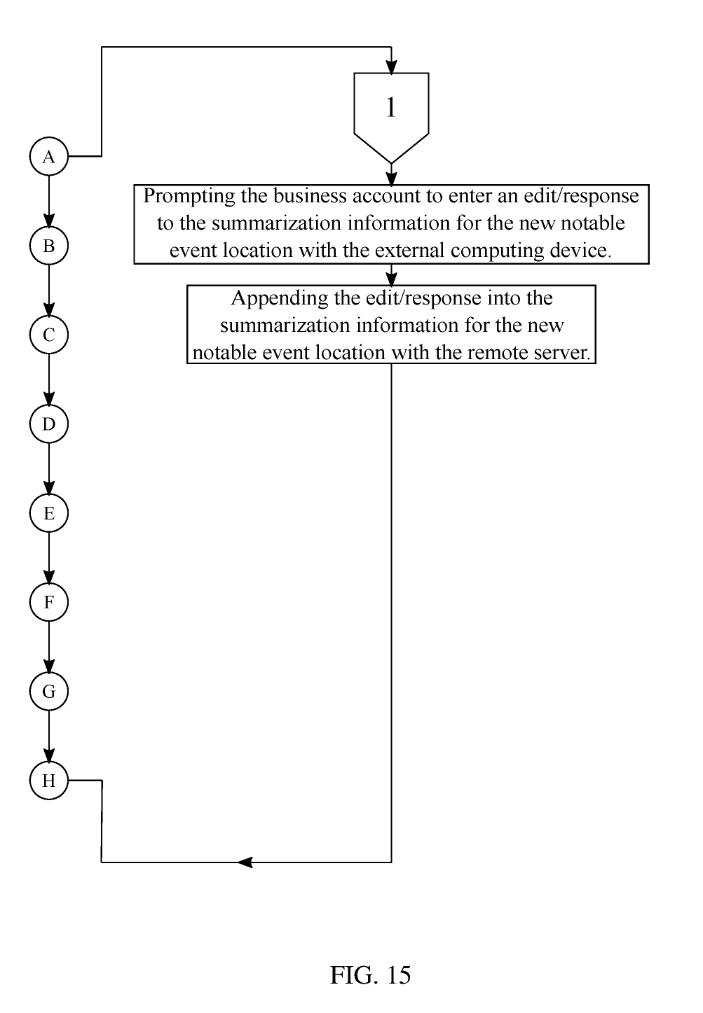

As seen in FIG. 14 and FIG. 15, a business account may be associated with the new notable event location, where the business account is managed by the remote server and is associated with an external computing device. The business account for the new notable event location may respond to a summarization information that has been posted to the new notable event location. In order for the business account to respond, the business account is prompted to enter an edit/response to the summarization information for the new notable event location with the external computing device. The edit/response is appended into the summarization information for the new notable event location with the remote server. For example, the edit/response may simply be a textual message or a redeemable coupon or offer.

Although the invention has been explained in relation to its preferred embodiment, it is to be understood that many other possible modifications and variations can be made without departing from the spirit and scope of the invention as hereinafter claimed.

What is claimed is:

1. A method of event planning through a social network, the method comprises the steps of:
(A) providing a plurality of user accounts managed by at least one remote server, wherein each user account is associated a corresponding personal computing (PC) device;
(B) providing a plurality of user relationships managed by the remote server, wherein the user accounts are linked amongst each other by the user relationships;
(C) receiving a planned-event location from the corresponding PC device of an arbitrary account, wherein the arbitrary account is any one of the plurality of user accounts;
(D) generating an event posting based on the planned-event location with the remote server;
(E) designating a plurality of related accounts to the arbitrary account based on the user relationships with the remote server, wherein the related accounts are from the plurality of user accounts;
(F) sending an event notification for the event posting to the corresponding PC device of each related account;
(G) prompting each related account to send an event confirmation for the event posting through the corresponding PC device; and,
(H) designating at least one attendee account for the event posting with the remote server, if the remote server receives the event confirmation from the corresponding PC device of the attendee account, wherein the at least one attendee account is from the plurality of related accounts.

2. The method of event planning through a social network, the method as claimed in claim 1 comprises the steps of:
prompting to textually enter a physical address through the corresponding PC device of the arbitrary account; and,
receiving the physical address as the planned-event location during step (C).

3. The method of event planning through a social network, the method as claimed in claim 1 comprises the steps of:
displaying an interactive geospatial map with the corresponding PC device of the arbitrary account;
prompting to graphically select a physical address on the interactive geospatial map through the corresponding PC device of the arbitrary account; and,
receiving the physical address as the planned-event location during step (C).

4. The method of event planning through a social network, the method as claimed in claim 3 comprises the steps of:
providing a plurality of notable event locations stored on the remote server; and,
graphically highlighting the plurality of notable event locations on the interactive geospatial map with the corresponding PC device of the arbitrary account.

5. The method of event planning through a social network, the method as claimed in claim 3 comprises the steps of:
providing a plurality of notable event locations stored on the remote server;
receiving a location filter from the corresponding PC device of the arbitrary account;
applying the location filter on the plurality of notable event locations in order to identify a plurality of desired locations from the plurality of notable event locations; and,
graphically highlighting the plurality of desired locations on the interactive geospatial map with the corresponding PC device of the arbitrary account.

6. The method of event planning through a social network, the method as claimed in claim 3 comprises the steps of:
providing a plurality of notable event locations stored on the remote server, wherein each of the plurality of notable event locations includes summarization information;
graphically highlighting the plurality of notable event locations on the interactive geospatial map with the corresponding PC device of the arbitrary account;
prompting to select a potential location from the plurality of notable event locations with the corresponding PC device of the arbitrary account; and,
displaying the summarization information of the potential location on the interactive geospatial map with the corresponding PC device of the arbitrary account.

7. The method of event planning through a social network, the method as claimed in claim 1 comprises the steps of:
providing a plurality of notable event locations stored on the remote server;
prompting the arbitrary account to select a plurality of future-endeavor locations from the plurality of notable event locations with the corresponding PC device; and,
graphically listing the plurality of future-endeavor locations with the corresponding PC device of the arbitrary account.

8. The method of event planning through a social network, the method as claimed in claim 1 comprises the steps of:
providing a plurality of notable event locations stored on the remote server, wherein each of the plurality of notable event locations includes an in-depth description;
prompting the arbitrary account to view the in-depth description of a potential location through the corresponding PC device; and,
displaying the in-depth description of the potential location with the corresponding PC device of the arbitrary account.

9. The method of event planning through a social network, the method as claimed in claim 1 comprises the steps of:
providing an interactive calendar for each user account managed by the remote server;
comparing the interactive calendar for the arbitrary account to the interactive calendar for each related account in order to identify a plurality of best-matching dates-and-times for the event posting;
prompting the arbitrary account to select a desired date-and-time from the plurality of best-matching dates-and times through the corresponding PC device of the arbitrary account; and,
setting the event posting to the desired date-and-time with the remote server.

10. The method of event planning through a social network, the method as claimed in claim 9 comprises the steps of:
chronologically integrating the desired date-and-time of the event posting into the interactive calendar of the arbitrary account and into the interactive calendar of each attendee account.

11. The method of event planning through a social network, the method as claimed in claim 1 comprises the steps of:
providing a plurality of notable event locations stored on the remote server, wherein each notable event location is associated with a physical address;
sending a current location for the corresponding PC device of the arbitrary account to the remote server;
comparing the current location to the physical address of each notable event locations in order to identify a matching location from the plurality of notable event locations;
prompting the arbitrary account to tag the matching location through the corresponding PC device of the arbitrary account; and,
storing an association between the arbitrary account and the matching location on the remote server.

12. The method of event planning through a social network, the method as claimed in claim 1 comprises the steps of:
providing a marital status for each user account stored on the remote server;
prompting the arbitrary account to select a filter based on the martial status with the corresponding PC device; and,
filtering the plurality of related accounts based on the filter on the marital status with the remote server.

13. The method of event planning through a social network, the method as claimed in claim 1 comprises the steps of:
providing a plurality of notable event locations stored on the remote server;
prompting the arbitrary account and each attendee account to tag the planned-event location with the corresponding PC device;
storing an association between the arbitrary account and the planned-event location on the remote server;
storing an association between each attendee account and the planned-event location on the remote server; and,
compiling the association between the arbitrary account and the planned-event location and the association between each attendee account and the planned-event location into a new notable event location with the remote server;
appending the new notable event location into the plurality of notable event locations with the remote server.

14. The method of event planning through a social network, the method as claimed in claim 13 comprises the steps of:
providing summarization information for each of the plurality of notable event locations stored on the remote server;
prompting the arbitrary account and each attendee account to select a likeability score for the new notable event location through the corresponding PC device; and,
appending the likeability score into the summarization information of the new notable event location with the remote server.

15. The method of event planning through a social network, the method as claimed in claim 13 comprises the steps of:
providing summarization information for each of the plurality of notable event locations stored on the remote server;
prompting the arbitrary account and each attendee account to enter a textual review for the new notable event location through the corresponding PC device; and,
appending the textual review into the summarization information of the new notable event location with the remote server.

16. The method of event planning through a social network, the method as claimed in claim 13 comprises the steps of:
providing summarization information for each of the plurality of notable event locations stored on the remote server;
providing a business account for the new notable event location, wherein the business account is managed by the remote server and is associated with an external computing device;
prompting the business account to enter an edit/response to the summarization information for the new notable event location with the external computing device; and,
appending the edit/response into the summarization information for the new notable event location with the remote server.
